(19) United States
(12) Patent Application Publication
(10) Pub. No.: US 2004/0234165 A1
(43) Pub. Date: Nov. 25, 2004

(54) Image interpolation apparatus and method

(75) Inventor: Jong-whan Lee, Gyeonggi-do (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/851,203

(22) Filed: May 24, 2004

(30) Foreign Application Priority Data
May 24, 2003 (KR) 2003-33183

(51) Int. Cl. G06K 9/32

(52) U.S. Cl. 382/300

(57) ABSTRACT

An image interpolation apparatus and an image interpolation method. The image interpolation apparatus including an image signal storage section which stores input image signals of a first resolution, a filtering selection section which outputs a filtering selection signal, a control section which calculates an interpolation position for each of a given number of input image signals, a coefficient storage section which stores a plurality of interpolation coefficients classified by the filters, and which outputs the given number of interpolation coefficients corresponding to the filtering selection signal and to the given number of calculated interpolation positions, and an interpolation filter, to which the given number of input image signals and the given number of interpolation coefficients are input from the image signal storage section and the coefficient storage section, respectively, and which executes the selected filtering to output image signals of a second resolution. Different filters are, thus, selectively applied according to frequencies of input images when up-scaling and transforming an image input in a predetermined resolution into another image of a different resolution, whereby degradation of image quality can be avoided.

### CROSS-REFERENCE TO RELATED APPLICATIONS

This application claims the benefit of Korean Application No. 2003-33183, filed May 24, 2003, in the Korean Intellectual Property Office, the disclosure of which is incorporated herein by reference.

### BACKGROUND OF THE INVENTION

1. Field of the Invention

The present invention relates to an image interpolation apparatus and an image interpolation method, and in particular, to an image interpolation apparatus and an image interpolation method, in which when an image inputted in a predetermined resolution is increased and transformed to an image of a different resolution by applying different filters depending on the frequency of the input image, thereby increasing the resolution of the image.

2. Description of the Related Art

In general, when an image having a resolution different from a resolution that was previously established in an image display apparatus is inputted into the image display apparatus from an image signal source, it is necessary to transform the resolution of the input image to correspond to the resolution previously established in the image display apparatus. Increasing or decreasing the resolution of an image by transforming the number of pixels when processing the image signals is referred to as scaling or format-transformation.

In particular, when an image having a resolution lower than a previously established resolution is inputted to an image display apparatus, the image display apparatus applies a predetermined linear interpolation in order to increase the resolution of the inputted image either vertically or horizontally.

U.S. Pat. No. 6,281,873, which is entitled “Video Line Ratio Vertical Scaler,” discloses a method for performing vertical scaling and filtering with the aid of a single processor by using a poly-phase filter.

Hereinbelow, the term, “image interpolation apparatus” refers to an apparatus for increasing the resolution by increasing the number of pixels with the aid of a predetermined linear interpolation method. Such an image interpolation apparatus is generally incorporated in an image display apparatus.

Examples of linear interpolation methods involve bi-linear interpolation, cubic convolution interpolation, etc. The bi-linear interpolation method and cubic convolution interpolation method use a finite impulse response (FIR) filter, in which an input image signal is transformed into a frequency region and then filtered by using a weighted value of pixels adjacent to a position to be interpolated. As a result, up-scaled, or increased, final interpolation data is output.

For example, the bi-linear interpolation method executes interpolation by applying a 2-tap filter as shown in FIG. 1(A) for input image signals. That is, the bi-linear interpolation method executes interpolation by using two pixels around a position to be interpolated.

Meanwhile, the cubic convolution interpolation method executes interpolation by applying a 4-tap filter as shown in FIG. 1(B) for input image signals. That is, the cubic convolution interpolation method executes interpolation by using four pixels around a position to be interpolated.

However, because such a conventional image interpolation apparatus executes only one interpolation method, i.e. interpolates by using only one filter which was previously established, degradation of image quality might result depending on respective frequency regions. For example, if the cubic convolution interpolation method is applied for input image signals, degradation of image quality is produced in an image signal region of a high frequency component, although such degradation of image quality is not caused in an image signal region free of a high frequency component.

Specifically, when pixels P1 to P8, sampled as shown in FIG. 2(A), are interpolated by using cubic convolution interpolation, it can be seen that section II is interpolated to a relatively low level of brightness as compared to sections I and III as shown in FIG. 2(B). In other words, section II, which consists of high frequency image signals, is more darkly interpolated as compared to sections I and III, which consists of low frequency image signals. Accordingly, in this case, it is desirable to apply another interpolation in section II, which scarcely causes degradation of the image quality in that section. However, such a conventional image interpolation apparatus has difficulty in preventing degradation of the image quality caused, for example, by aliasing produced in a high frequency image signal region as shown in FIG. 2(B), because it executes image interpolation with the aid of only one filter.

### SUMMARY OF THE INVENTION

Accordingly, the present invention has been made to solve the above-mentioned problems occurring in the prior art, and an aspect of the present invention is to provide an image interpolation apparatus and an image interpolation method, which allow for adaptively selecting any one from at least two finite impulse response filters to interpolate an input image when increasing the resolution of the input image on the basis of a predetermined transformation ratio of resolution.

In order to achieve the above aspect, according to present invention, there is provided an image interpolation apparatus, which interpolates input image signals of a first resolution to output image signals of a second resolution according to a transformation ratio of resolution, wherein the image interpolation apparatus comprises an image signal storage section which is stored with the input image signals; a filtering selection section which outputs a filtering selection signal for a desired one of at least two different interpolation filters according to a brightness level pattern of a given number of the input image signals sequentially inputted from the signal storage section; a control section which calculates an interpolation position for each of the given numbers of the input image signals according to the transformation ratio of resolution; a coefficient storage section which is stored with a plurality of interpolation coefficients classified by the filters, and which outputs the given number of the interpolation coefficients corresponding to the filtering selection signal and to the given number of the calculated interpolation positions; and an interpolation filter, to which the given number of the input image signals and the given number of the interpolation coefficients corresponding to the filtering selection signal are inputted from the image signal storage section and the coefficient storage section, respectively, and which executes the selected filtering to output the output image signals.

Preferably, the at least two filters are a 4-tap filter and an 8-tap filter.

In addition, the filtering selection section outputs a selection signal for the 4-tap filter if it is determined that the brightness level pattern is any of a pattern in which the brightness levels of the given number of the input image signals continuously increase over previously established times and a pattern in which the brightness levels of the given number of the input image signals continuously decrease over previously established times.

Further, if the brightness levels of two input image signals continuously inputted among the given number of the input image signals are the same, the filter selection section applies a prior brightness level pattern determined prior to determining the brightness level pattern between the two input image signals as the brightness level pattern of the two input image signals.

Further, if the difference between the brightness levels of the two input image signals is lower than a previously established reference level, the filter selection section applies a prior brightness level pattern determined prior to determining the brightness level pattern between the two input image signals as the brightness level pattern of the two input image signals.

Preferably, the previously established times are at least two times.

More particularly, the at least two filters are a plurality of finite impulse response filters including an 8-tap filter.

In addition, the interpolation filter comprises a plurality of delayers which output the given number of the input image signals sequentially inputted from the image signal storage section, after delaying the input image signals for a predetermined length of time; a plurality of multipliers which respectively multiply the given number of the input image signals outputted from the plurality of the delayers and the given number of the coefficients outputted from the coefficient storage section to output the given number of interpolation data; and an adder which adds the given number of the interpolation data outputted from the plurality of multipliers to output the output image signals.

The control section controls the velocities of the input image signals inputted into the interpolation filter from the image signal storage section according to the transformation ratio of resolution.

In order to achieve the above object, there is also provided an image interpolation method, which interpolates input image signals of a first resolution to output image signals of a second resolution according to a transformation ratio of resolution, wherein the method comprises outputting a filtering selection signal for a desired one of at least two different interpolation filters according to a brightness level pattern of a given number of the input image signals which are sequentially inputted; calculating an interpolation position for each of the given number of the input image signals according to the transformation ratio of resolution; outputting the given number of interpolation coefficients corresponding to the filtering selection signal and to the given number of the calculated interpolation positions among a plurality of stored interpolation coefficients; and receiving the given number of the input image signals and the given number of the interpolation coefficients corresponding to the filtering selection signal and performing the selected filter to output the output image signals.

More particularly, the at least two filters are a 4-tap filter and an 8-tap filter.

In addition, the filter selection step outputs a selection signal for the 4-tap filter if it is determined that the brightness level pattern is any of a pattern in which the brightness levels of the given number of the input image signals continuously increase over previously established times and a pattern in which the brightness levels of the given number of the input image signals continuously decrease over previously established times.

Further, if the brightness levels of two input image signals continuously inputted among the given number of the input image signals are the same, the filter selection step applies a prior brightness level pattern determined prior to determining the brightness level pattern between the two input image signals as the brightness level pattern of the two input image signals.

Still further, if the difference between the brightness levels of the two input image signals is lower than a previously established reference level, the filter selection step applies a prior brightness level pattern determined prior to determining the brightness level pattern between the two input image signals as the brightness level pattern of the two input image signals.

Preferably, the filtering step comprises outputting the given number of the input image signals sequentially inputted from the image signal storage section, after delaying the input image signals for a predetermined length of time; respectively multiplying the given number of the input image signals outputted from the plurality of the multipliers and the given number of the coefficients outputted from the coefficient storage section to output the given number of interpolation data; and adding the given number of the interpolation data outputted from the multiplying step to output the output image signals.

### BRIEF DESCRIPTION OF THE DRAWINGS

The above and other aspects, features and advantages of the present invention will be more apparent from the following detailed description taken with reference to the accompanying drawings, in which:

FIG. 1 is a drawing for illustrating a method for executing interpolation by using a conventional interpolation method;

FIG. 2 is a drawing for illustrating a problem produced when performing interpolation using a cubic convolution interpolation applied to conventional image interpolation apparatuses;

FIG. 3 is a block diagram schematically showing an image interpolation according to a preferred embodiment of the present invention;

FIG. 4 is a drawing showing eight input image signals, which are sequentially inputted, in order to illustrate an embodiment in which the filtering selection section of FIG. 3 outputs a filtering selection signal for a desired filtering;

FIG. 5 is a drawing for illustrating a case in which the filtering selection section determines whether the eight input image signals sequentially inputted belong to a graphic region or an edge region;

FIGS. 6A and 6B are drawings for illustrating an embodiment of interpolation positions calculated according to a transformation ratio of resolution in the control section shown in FIG. 3;

FIG. 7 is a drawing for illustrating a method for producing interpolation coefficients with the aid of given interpolation positions calculated in the control section shown in FIG. 3; and

FIG. 8 is a flowchart for schematically illustrating an image interpolation method using the image interpolation apparatus shown in FIG. 3.

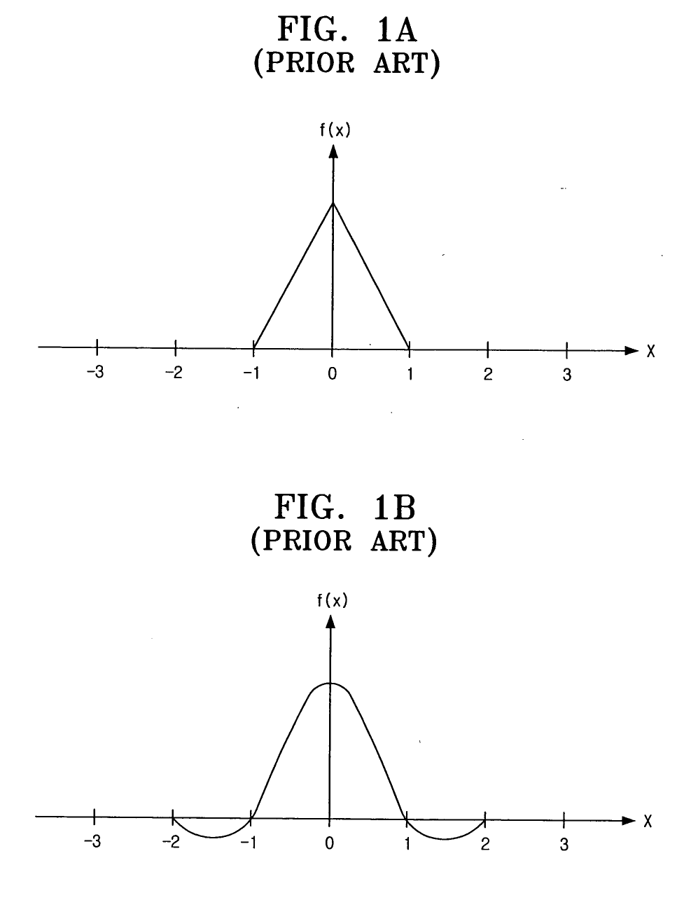

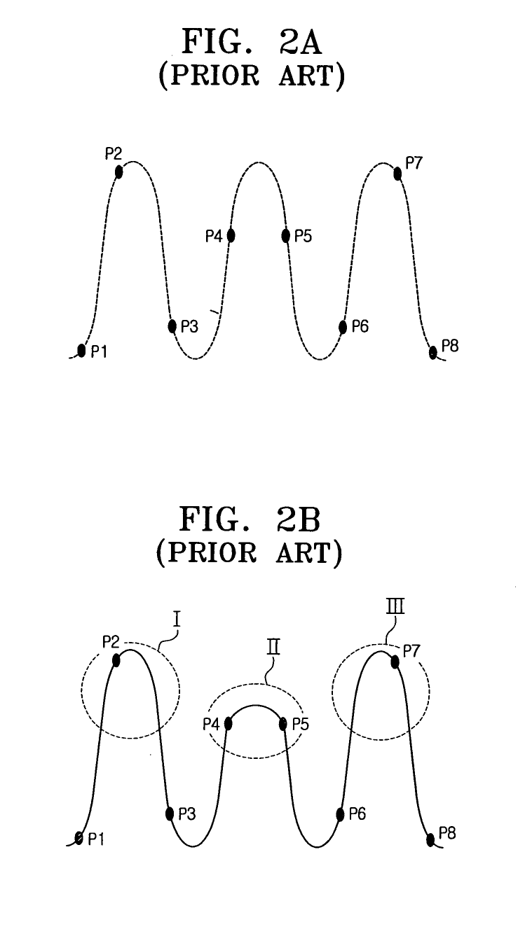

### DETAILED DESCRIPTION OF THE PREFERRED EMBODIMENTS

Hereinbelow, the present invention will be described in detail with reference to the accompanying drawings.

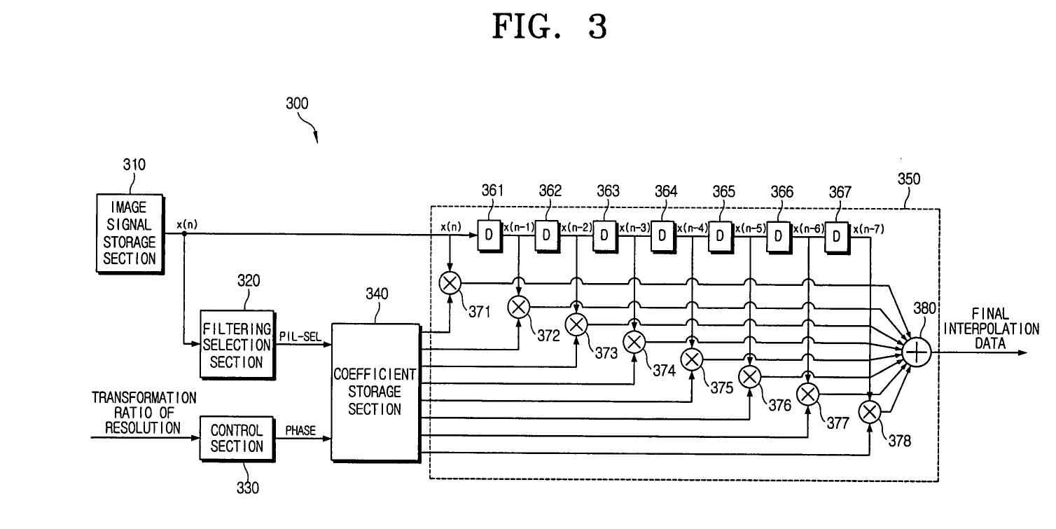

Referring to FIG. 3, an image interpolation apparatus 300 according to a preferred embodiment of the present invention comprises an image signal storage section 310, a filtering selection section 320, a control section 330, a coefficient storage section 340 and an interpolation filter 350.

In general, an apparatus for increasing image resolution by increasing the number of pixels using a interpolation method may be referred to by various names, such as scaler, format transform apparatus, image up-scaling apparatus, etc. Herein, however, such an apparatus will be referred to as an image interpolation apparatus.

The image interpolation apparatus 300 is an apparatus for up-scaling, i.e., increasing the resolution of, input image signals of a first resolution in output image signals of a second resolution according to a predetermined transformation ratio of resolution. The transformation ratio of resolution is a ratio of input and output resolutions before and after interpolation, and the output image signals are final interpolated data outputted from the image interpolation apparatus 300.

The image signal storage section 310 is stored with image signals inputted from an image signal source. The image signal storage section 310 provides the input image signals for the filtering selection section 320 and the interpolation filter 350 under the control of the control section 320 to be described later.

The filtering selection section 320 analyzes an increase or decrease in brightness levels of the input image signals sequentially input from the image signal storage section 310. The filtering selection section 320 outputs a filtering selection signal for a desired one of at least two different filters on the basis of the analysis result. Specifically, the filtering selection section 320 determines a frequency of the input image signals and outputs a filtering selection signal.

The present invention will be described in connection with a case in which a 4-tap filter using cubic convolution interpolation and an 8-tap filter using poly-phase interpolation are applied as the at least two filters, as an example. Here, the 4-tap filter executes interpolation for low frequency image signals having a frequency lower than a reference frequency, while the 8-tap filter executes interpolation for image signals having a frequency higher than the reference frequency.

More specifically, the filtering selection section 320 determines whether there exists a pattern in which the brightness levels of input image signals continuously increase or decrease over a previously established time for a given number of input image signals. And, if it is determined that such a pattern exists, the filtering selection section 320 determines it as a low frequency region and outputs a filtering selection signal for the 4-tap filter. Whereas, if it is determined that such a pattern does not exist, the filtering selection section 320 outputs a filtering selection signal for the 8-tap filter.

Here, if the brightness levels of two input image signals are continuously the same, the filtering selection section 320 determines that the prior brightness level pattern determined prior to determining the new brightness level pattern (i.e., increase or decrease) of the two input image signals is maintained. In other words, the brightness level pattern determined prior to determining the new brightness level pattern of the two image signals having a same brightness level is determined as an increase pattern, the filtering selection section determines the brightness levels of the two image signals as being increased even if the brightness levels of the two input image signals continuously input are equal

In addition, if the difference in brightness levels of the two input image signals continuously input among the given number of the input image signals is lower than a previously established reference level, the filtering selection section 320 determines that the brightness level pattern of two other input image signals determined prior to determining the new brightness level pattern of the two input image signals is maintained. This is to prevent an edge region from being determined as a high frequency region by recognizing the edge as image signals interleaved with a noise signal.

If the comparison regarding an increase or decrease in brightness levels for the given number of input image signals is completed, the first input image signal is cleared from the given number of the input image signals, and a new input image signal is sequentially input into the filtering selection section 320.

In one embodiment of the present invention, a filtering selection signal is outputted by comparing brightness levels of eight input image signals, which are sequentially inputted, and determining whether there exists a pattern where the brightness level continuously increases or decreases at least three times.

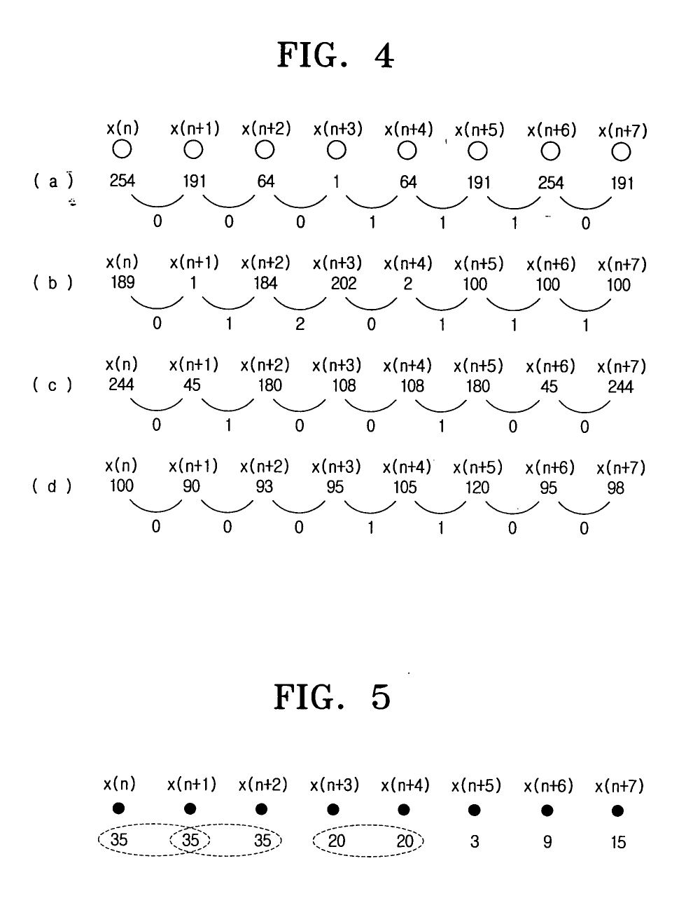

FIG. 4 shows eight input image signals, which are sequentially input, in order to illustrate an embodiment in which the filtering selection section outputs a filtering selection signal for a desired filtering.

In FIG. 4, the first to the eighth input image signals, x(n) to x(n+7), are expressed in predetermined brightness levels, respectively, in which the image signals correspond to sequentially input pixels. In addition, the numbers indicated below the first to eighth input image signals x(n) to x(n+7) refer to corresponding brightness levels, respectively.

Referring to FIG. 4(a), it can be seen that the brightness levels continuously decrease over the first three consecutive times, i.e., from the first input image signal x(n) to the fourth input image signal x(n+3), while the brightness levels continuously increase over the three consecutive times from the fourth input image signal x(n+3) to the seventh input image signal x(n+6). In this case, the filtering selection section 320 outputs the 4-tap filter selection signal.

More preferably, the filtering selection section 320 calculates differences in brightness levels or frequencies of image signals as being continuously input, and if the brightness levels decrease, then a ‘1’ is indicated, while if the brightness levels increase, then a ‘0’ is indicated. Based on the indicated result, the filtering selection section 320 determines whether the brightness levels form an increase pattern or a decrease pattern. For example, in FIG. 4(a), the brightness levels decreased between the first input image signal x(n) and the second input image signal x(n+1), and thus ‘0’ is indicated. Whereas, the brightness levels increased between the fourth input image signal x(n+3) and the fifth input image signal x(n+4), thus ‘1’ is indicated. As a result of such indication, there exist sections, in which ‘1’ or ‘0’ is continuously indicated over three times. Therefore, the filtering selection section 320 outputs a selection signal for the 4-tap filtering.

Referring to FIG. 4(b), it can be seen that the brightness levels are same over the sixth to eighth input image signals. Here, because the brightness levels increased between the fifth input signal x(n+4) and the sixth input signal x(n+5), the filtering selection section 320 determines that the brightness levels also increased over the sixth to the eighth input image signals x(n+5) to x(n+7). Therefore, the filtering selection section 320 determines that the brightness levels over the fifth to eighth input image signals x(n+4) to x(n+7) form an increase pattern of which brightness levels continuously increase over three consecutive times and, thus, the filtering selection section 320 outputs the 4-tap filtering selection signal.

Referring to FIG. 4(c), it can be seen that there is no interval in which the brightness levels continuously increase or decrease over three consecutive times from the first to eighth input image signals x(n) to x(n+7). In this case, the filtering selection section 320 outputs the 8-tap filtering selection signal.

Referring to FIG. 4(d), the brightness levels decrease between the first input image signal x(n) and the second input image signal x(n+1), whereas the brightness levels increase between the second input image signal x(n+1) and the third input image signals x(n+2). However, because the difference between the brightness levels of the first input image signal x(n) and the second input image signal x(n+1) is lower than the previously established level, 5, the filtering selection section 320 determines that the previously determined pattern remains as a decrease pattern.

This is identically applied to the brightness levels between the third input image signal x(n+2) and the fourth input image signal x(n+4). In the case shown in FIG. 4d, the filtering selection section 320 determines that the brightness levels form a decrease pattern, of which the brightness levels continuously decrease over three consecutive times and thus the filtering selection section 320 outputs the 4-tap filtering selection signal.

In addition, if there exist at least two sections, of which the brightness levels of two input image signals continuously input are the same for a given number of input image signals inputted from the image signal storage section 310, the filtering selection section 320 determines the given number of the input image signals as belonging to a graphic region or an edge region. In this case, the filtering selection section 320 outputs the 4-tap filtering selection signal. Because a ringing phenomenon is produced if the 8-tap filter is applied to the graphic region or the edge region in this case, the filtering selection section 320 outputs the selection signal for the 4-tap filter.

For example, when the brightness levels of the first to eighth input image signals x(n) to x(n+7) are as shown in FIG. 5, there exist three sections (indicated by dotted lines), in each of which two input image signals continuously input are equal in brightness level. Therefore, the filtering selection section 320 determines that the given number of input image signals which are input as shown in FIG. 5 belong to a graphic region or an edge region and thus the filtering selection section 320 outputs the 4-tap filtering signal. In FIG. 5, the numbers indicated below the first to eighth input image signals x(n) to x(n+7) refer to brightness level.

The control section 330 controls input velocity of the input image signals inputted from the image signal storage section 310 into the interpolation filter 350 to be described later, according to a transformation ratio of resolution. This is the case in which the present invention relates to image up-scaling, or an increase in resolution. In the case of image down-scaling, or a decrease in resolution, the control section 330 controls the output velocity of the output image signal output from the interpolation filter 350. In addition, the control section 330 calculates an interpolation position for each of the given number of input image signals input into the filtering selection section 320 according to a transformation ratio of resolution.

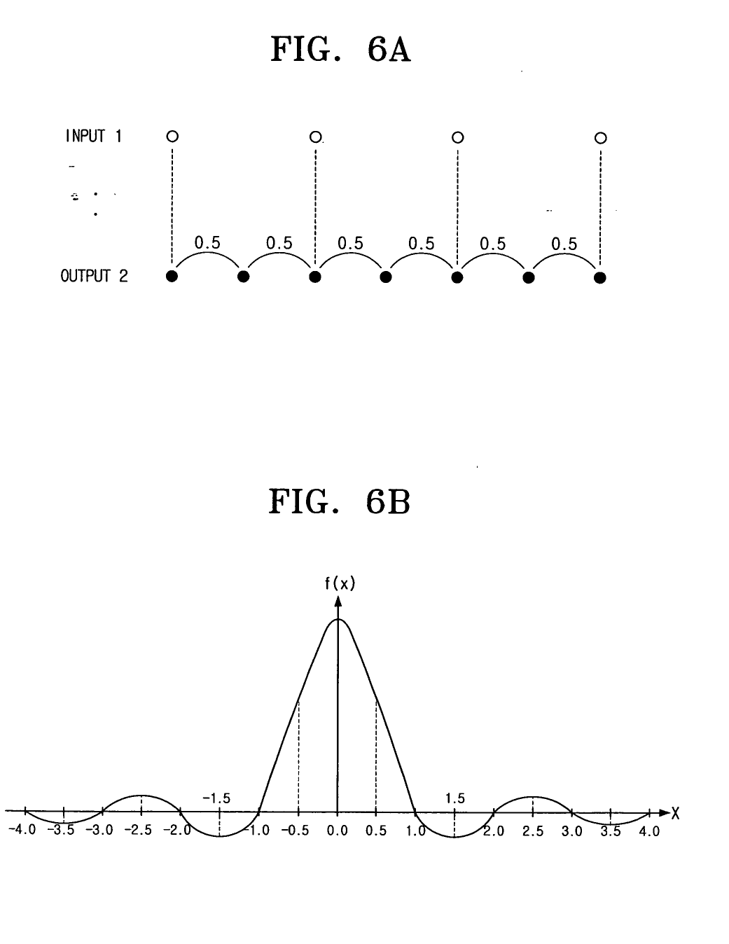

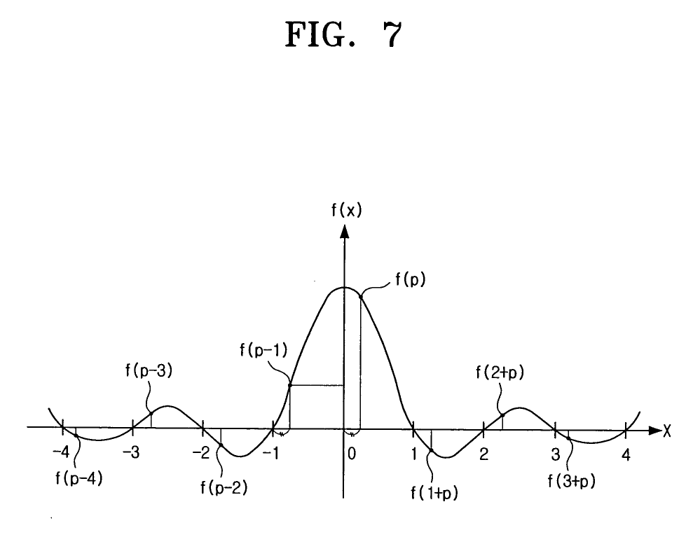

FIGS. 6A and 6b are drawings for illustrating interpolation positions calculated according to a predetermined transformation ratio of resolution in the control section shown in FIG. 3.

Referring to FIG. 6A, the white circles indicate positions of input image signals and the black circles indicate interpolation positions calculated according to a transformation ratio of resolution.

Specifically, if the transformation ratio is 1:2 as shown in FIG. 6A, the scale factor in the horizontal direction is 0.5. Therefore, if horizontal interpolation is executed by using an 8-tap poly-phase interpolation kernel as shown in FIG. 6B, it can be seen that the interpolation positions for input image signals correspond to −3.5, −2.5, −1.5, −0.5, +0.5, +2.5 and +3.5, respectively. As another example, if the transformation ratio of resolution is 3:5, the scale factor in the horizontal direction is 0.6.

The coefficient storage section 340 stores interpolation coefficients corresponding to a plurality of interpolation positions, that is, tap weight values, in which the interpolation coefficients of tap weight values are classified by the filters. The interpolation coefficients can be calculated by using the 8-tap poly-phase interpolation kernel as shown in FIG. 7.

FIG. 7 is a drawing for illustrating a method for producing coefficients on the basis of the predetermined interpolation positions calculated in the control section of FIG. 3.

Referring to FIG. 7, in the 8-tap poly-phase interpolation kernel, eight input image signals are participated in interpolation. In addition, when a plurality of interpolation positions are (p−4), (p−3), (p−2), (p−1), (p), (p+1), (p+2) and (p+3), a plurality of interpolation coefficients needed for obtaining final interpolation data are f(p−4), f(p−3), f(p−2), f(p−1), f(p), f(p+1), f(p+2) and f(p+3). Here, p is a relative positional value in each interval of taps.

These interpolation coefficients are previously calculated by the 8-tap poly-phase interpolation kernel and stored in the coefficient storage section 340. For example, if each interval between taps is divided into 32 sections, interpolation positions in an interval between taps will have relative positional values such as 0, 1/32, 2/32, 3/32, . . . , 31/32, 1, respectively, and vertical and horizontal interpolation coefficients corresponding to respective interpolation positions are calculated in advance and stored in the coefficient storage section 340. Meanwhile, each interval between taps is capable of being divided into another number of sections, such as 16 sections, 64 sections, etc.

In accordance with the present invention, the coefficient storage section 340 is stored with horizontal interpolation coefficients for 4-tap filtering and 8-tap filtering.

Therefore, the coefficient storage section 340 outputs horizontal interpolation coefficients corresponding to the filtering selection signal output from the filtering selection section 320 and to a given number of interpolation positions calculated from the control section 330.

That is, when the 8-tap filtering is selected by the filtering selection section 320, the coefficient storage section 340 outputs eight interpolation coefficients. Whereas, if the 4-tap filtering is selected by the filtering selection section 320, the coefficient storage section 340 outputs eight interpolation coefficients, in which 2 taps at each end of the 8-taps have an interpolation coefficient of ‘0’. This is because the interpolation 350 to be described later is provided with eight multipliers 371 to 378, and the 4-tap filtering performs interpolation using four interpolation coefficients.

The calculation of interpolation positions and filtering coefficients corresponding to respective interpolation positions according to a transformation ratio of resolution is an already known technology and thus one skilled in the art knows such a technology. Therefore, detailed description thereof is omitted.

The interpolation filter 350 selectively provides a desired one of at least two FIR filters for executing interpolation in the horizontal direction using interpolation coefficients outputted from the coefficient storage section 340. According to the present invention, the 4-tap filter and the 8-tap filter are applied as the at least two FIR filters. However, it is possible to apply not only a 4-tap filter but also a 2-tap filter. In addition, the interpolation filter 350 calculates final interpolation data in the horizontal direction using a given number of input image signals sequentially input from the image signal storage section 310 and a given number of interpolation coefficients output from the coefficient storage section 340.

For this purpose, the interpolation filter 350 includes first to seventh delayers 361 to 367, first to eighth multipliers 371 to 378, and an adder 380.

The first to seventh delayers 361 to 367 (in the drawing, reference symbol ‘D’ refers to ‘delay’) delay the input image signals sequentially input from the image signal storage section for a predetermined length of time, and outputs delayed input image signals to the second to eighth multipliers 372 to 378. Therefore, if the input image signal x(n) is delayed in the first delayer 361, the sixth input image signal x(n−6) is delayed in the seventh delayer 367 for a predetermined length of time.

More specifically, the first delayer 361 receives the input image signal x(n) and outputs the first delay image signal x(n−1) delayed for a predetermined length of time to the second delayer 362 and the second multiplier 372.

The second delayer 362 delays the first delay image signal x(x−1) inputted from the first delayer 361 for a predetermined length of time and then outputs the second delay image signal x(n−2) delayed for the predetermined length of time to the third delayer 363 and the third multiplier 373.

The third to sixth delayers 363 to 366 receive input image signals and output delay signals after delaying the input image signals for a predetermined length of time, in a same manner as described above. Therefore, detailed description is omitted.

In addition, the seventh delayer 367 delayers the sixth delay image signal x(n−6) inputted from the second delayer 366 for a predetermined length of time and outputs the seventh delay image signal x(n−7) delayed for the predetermined length of time to the eighth multiplier 378.

The first to eighth multipliers 371 to 378 multiply the brightness levels of input image signals delayed in each of the delayers and the interpolation coefficients outputted from the coefficient storage section 340 and corresponding to the input image signals, respectively.

In more detail, the first multiplier 371 multiplies the input image signal x(n) inputted from the image signal storage section 310 and an interpolation coefficient corresponding to the input image signal x(n), thereby producing a first interpolation data.

In addition, the second multiplier 372 multiplies the first delay image signal x(n−1) inputted from the first delayer 361 and an interpolation coefficient corresponding thereto, thereby producing a second interpolation data.

Similarly, the third to eighth multipliers 371 to 378 respectively multiply the second to seventh delay image signals x(n−2) to x(n−7) inputted from the second to seventh delayers 361 to 367 and interpolation coefficients corresponding thereto, thereby producing third to eighth interpolation data.

In this case, if the 8-tap filter is selected by the filtering selection section 320, the coefficient storage section 340 outputs eight interpolation coefficients corresponding to the multipliers, respectively. Meanwhile, if the 4-tap filter is selected by the filtering selection section 320, the coefficient storage section 340 outputs ‘0’ for interpolation coefficients corresponding to the first, second, seventh and eighth multipliers 371, 372, 377 and 378, respectively, and outputs another four interpolation coefficients corresponding to the multipliers 371 to 378, respectively. As a result, the interpolation filter 350 will adaptively apply any one of the 4-tap filter and the 8-tap filter according to a brightness pattern of the input image signals, thereby producing final interpolation data.

The adder 380 adds all the first and eighth interpolation data output from the first to eighth multipliers 371 to 378, thereby outputting a final interpolation data. As a result, the interpolation filter 350 will execute horizontal up-scaling of input image signals through horizontal interpolation.

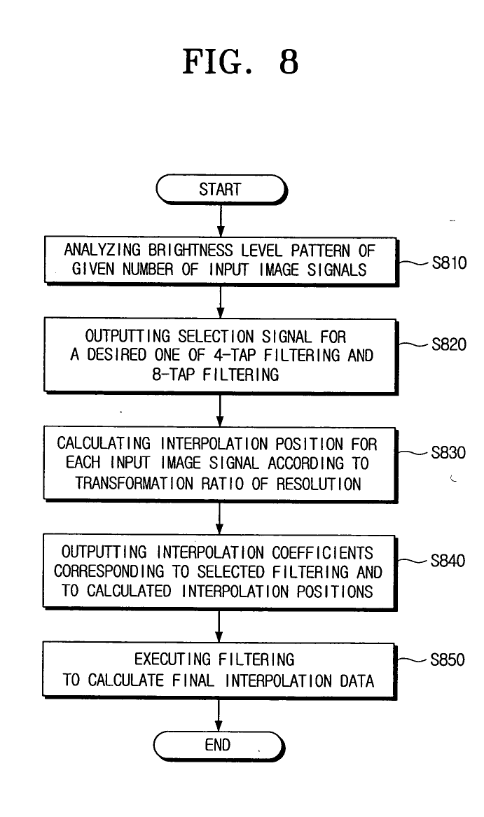

FIG. 8 is a flowchart for schematically illustrating an image interpolation method by the image interpolation apparatus shown in FIG. 3.

Referring to FIGS. 3 to 8, at first, the filtering selection section 320 analyzes a brightness level pattern for a given number of input image signals sequentially input from the image signal storage section (step 810). If step 810 is executed, the filtering selection section 320 outputs a selection signal for a desired one of the 4-tap filter and 8-tap filter to the coefficient storage section according to the analyzed brightness level pattern (step 820). Here, the brightness level pattern means an increase or a decrease in brightness levels of sequentially inputted image signals.

Further, the control section 330 calculates interpolation positions corresponding to the given number of the input image signals, respectively, according to a transformation ratio of resolution, and then outputs the calculated interpolation positions to the coefficient storage section 340 (step 830). If step 830 is executed, then the coefficient storage section 340 outputs the given number of the coefficients corresponding to the filtering selection signal and to the calculated interpolation positions output from step 820 and step 830, respectively (step 840).

After step 840, the interpolation filter 350 respectively multiplies the input image signal x(n) and the first to seventh delay image signals x(n−1) to x(n−7) input from the image signal storage section 310 and coefficients corresponding thereto, and produces first to eighth interpolation data. The interpolation filter 350 adds the first to eighth interpolation signals and outputs the final interpolation data (step 850). As a result, the interpolation of input image signals are executed by using a desired filter selected by the filtering selection section 320.

The image interpolation apparatus and method are described above in connection with the cases in which any one of a 4-tap filter which is a cubic convolution interpolation filter and an 8-tap filter which is a poly-phase interpolation filter is adaptively selected to interpolate an image. However, it is also possible to apply a 2-tap filter instead of the 4-tap filter.

In addition, although the image interpolation apparatus and method are described only in connection with the horizontal interpolation, it is of course possible to apply the present invention to vertical interpolation.

Furthermore, the image interpolation apparatus and method can execute more clear interpolation by determining whether input image signals belong to a graphic region or an edge region by determining frequencies according to brightness levels of input image signals.

As described above, according to the image interpolation apparatus and method, it is possible to interpolate an image by selectively applying filters different from each other according to frequencies of input images when up-scaling and transforming an image inputted in a predetermined resolution into another image of a different resolution. Therefore, in image interpolation, high frequency image signals are interpolated by using an 8-tap filter, whereby it is possible to avoid degradation of image quality caused, for example, by aliasing, while low frequency image signals are interpolated by using a 4-tap filter, whereby it is possible to avoid degradation of image quality caused, for example, by ringing.

While the preferred embodiments of the present invention has been shown and described with reference to the preferred embodiments thereof, the present invention is not limited to the embodiments. It will be understood that various modifications and changes can be made by those skilled in the art without departing from the spirit and scope of the invention as defined by the appended claims. It shall be considered that such modifications, changes and equivalents thereof are all included within the scope of the present invention.

What is claimed is:

1. An image interpolation apparatus, which interpolates input image signals of a first resolution to output image signals of a second resolution according to a transformation ratio of resolution, wherein the image interpolation apparatus comprises:
an image signal storage section operable to store the input image signals;
a filtering selection section operable to output a filtering selection signal for a desired one of at least two different interpolation filters according to a brightness level pattern of a given number of the input image signals sequentially input from the signal storage section;
a control section operable to calculate an interpolation position for each of the given number of input image signals according to the transformation ratio of resolution;
a coefficient storage section operable to store a plurality of interpolation coefficients classified by the filters, and further operable to output the given number of interpolation coefficients corresponding to the filtering selection signal and to the given number of calculated interpolation positions; and
an interpolation filter, to which the given number of input image signals and the given number of interpolation coefficients corresponding to the filtering selection signal are input from the image signal storage section and the coefficient storage section, respectively, and which is operable to execute the selected filter to output the output image signals.

2. The apparatus according to claim 1, wherein the at least two filters are a 4-tap filter and an 8-tap filter.

3. The apparatus according to claim 2, wherein the filtering selection section is operable to output a filtering selection signal for the 4-tap filter if it is determined that the brightness level pattern is either a pattern in which the brightness levels of the given number of input image signals continuously increase over a previously established number of times and a pattern in which the brightness levels of the given number of input image signals continuously decrease over a previously established number of times.

4. The apparatus according to claim 3, wherein if the brightness levels of two input image signals continuously input among the given number of input image signals are the same, the filtering selection section applies a prior brightness level pattern determined prior to determining the brightness level pattern between the two input image signals as the brightness level pattern of the two input image signals.

5. The apparatus according to claim 3, wherein if the difference between the brightness levels of the two input image signals is lower than a previously established reference level, the filtering selection section applies a prior brightness level pattern determined prior to determining the brightness level pattern between the two input image signals as the brightness level pattern of the two input image signals.

6. The apparatus according to claim 3, wherein the previously established number of times is at least two.

7. The apparatus according to claim 1, wherein the at least two filters is a plurality of finite impulse response filters including an 8-tap filter.

8. The apparatus according to claim 1, wherein the interpolation filter comprises:
a plurality of delayers operable to output the given number of input image signals sequentially input from the image signal storage section after delaying the input image signals for a predetermined length of time;
a plurality of multipliers operable to respectively multiply the given number of input image signals output from the plurality of delayers and the given number of coefficients output from the coefficient storage section to output the given number of interpolation data; and
an adder operable to add the given number of interpolation data output from the plurality of multipliers to output the output image signals.

9. The apparatus according to claim 1, wherein the control section is operable to control the velocities of the input image signals input into the interpolation filter from the image signal storage section according to the transformation ratio of resolution.

10. An image interpolation method for interpolating input image signals of a first resolution to output image signals of a second resolution according to a transformation ratio of resolution, wherein the method comprises:
outputting a filtering selection signal for a desired one of at least two different interpolation filters according to a brightness level pattern of a given number of input image signals which are sequentially input;
calculating an interpolation position for each of the given number of input image signals according to the transformation ratio of resolution;
outputting the given number of interpolation coefficients corresponding to the filtering selection signal and to the given number of calculated interpolation positions among a plurality of stored interpolation coefficients; and
receiving the given number of input image signals and the given number of interpolation coefficients corresponding to the filtering selection signal and performing the selected filtering to output the output image signals.

11. The method according to claim 10, wherein the at least two filters are a 4-tap filter and an 8-tap filter.

12. The method according to claim 11, wherein the filtering selection step outputs a filtering selection signal for the 4-tap filter if it is determined that the brightness level pattern is any of a pattern in which the brightness levels of the given number of input image signals continuously increase over a previously established time, and a pattern in which the brightness levels of the given number of input image signals continuously decrease over a previously established time.

13. The method according to claim 12, wherein if the brightness levels of two input image signals continuously input among the given number of input image signals are the same, the filtering selection section applies a prior brightness level pattern determined prior to determining the brightness level pattern between the two input image signals as the brightness level pattern of the two input image signals.

14. The apparatus according to claim 12, wherein if a difference between the brightness levels of the two input image signals is lower than a previously established reference level, the filtering selection section applies a prior brightness level pattern determined prior to determining the brightness level pattern between the two input image signals as the brightness level pattern of the two input image signals.

15. The method according to claim 10, wherein the step of performing the selected filtering comprises:
outputting the given number of input image signals, which are sequentially input, after delaying the input image signals for a predetermined length of time;
respectively multiplying the given number of input image signals output in the delaying step and the given number of coefficients output from the interpolation coefficient outputting step to output a given number of interpolation data; and
adding the given number of the interpolation data output from the multiplying step to output the output image signals.
